(19) United States
(12) Patent Application Publication
(10) Pub. No.: US 2025/0214834 A1
(43) Pub. Date: Jul. 3, 2025

(54) DEVICE FOR STORING HYDROGEN IN SOLID FORM

(71) Applicant: MINCATEC ENERGY, MEROUX-MOVAL (FR)

(72) Inventors: Emmanuel BOUTELEUX, MEROUX-MOVAL (FR); Sakreddine MANAI, MEROUX-MOVAL (FR); Yann GENNINASCA, MEROUX-MOVAL (FR)

(21) Appl. No.: 18/835,103

(22) PCT Filed: Feb. 3, 2023
(86) PCT No.: PCT/EP2023/052686

§ 371 Date: Aug. 1, 2024

(30) Foreign Application Priority Data
Feb. 11, 2022 (FR) FR2201193

(51) Int. Cl. C01B 3/00; B01J 20/02; B01J 20/28; F17C 11/00

(52) U.S. Cl. CPC C01B 3/0084; B01J 20/0229; B01J 20/28042; C01B 3/0031; F17C 11/005; F17C 2201/0119; F17C 2205/0323; F17C 2221/012

(57) ABSTRACT

The invention relates to a hydrogen storage pellet enabling the production of compact, modular, safe and energy-efficient hydrogen reservoirs. The pellet according to the invention comprises a peripheral ring (4) having an outer diameter of expanded natural graphite (ENG) of a determined height, surrounding a wafer of a metal hydride (5) in the form of compacted powder.

The invention relates to a device for storing hydrogen in solid form, in particular for producing compact and modular tanks for storing hydrogen in the form of low-pressure metal hydrides.

Hydrogen is used in many industrial fields, notably as a fuel or as a reagent. In this context, in consideration of its volume in the gaseous state and its explosiveness in air, it is desirable for hydrogen to be stored in a form that occupies limited space and ensures safe containment.

There are currently three major technologies.

The first involves storing gaseous hydrogen at very high pressure (between 350 bar and 700 bar) to compress it in tanks which are designed to withstand such pressures, and which are therefore costly. This type of storage also requires a significant amount of energy to compress and cool the hydrogen. The energy balance when using hydrogen with this storage method is therefore poor.

The second technology involves storing hydrogen in liquid form. It is then necessary to maintain a temperature below −252.87° C. to liquefy the hydrogen in the tanks. This type of storage requires a significant amount of energy to keep the hydrogen liquefied.

The third technology involves storing gaseous hydrogen in a solid medium in the form of compacted metal hydride powder.

This technology provides safer storage conditions and limited energy costs. Some metals or alloys are able to reversibly incorporate hydrogen atoms in the crystal lattice. The hydrogen is absorbed/desorbed by these materials as a function of the temperature and pressure conditions. Examples include palladium (Pd), magnesium (Mg), ZrMn2, Mg2Ni or alloys such as Mg—Mg2Ni or alanates.

By convention, the term “metal hydride” as used here covers, depending on the step of the method, the metal partially or completely charged with hydrogen.

Two types of metal hydrides are generally recognized: heavy hydrides (mainly LaNi5, and alloys such as ferrotitanium alloy or Ti—V—Cr alloy) and light hydrides (mainly magnesium and lithium).

With heavy hydrides, hydrogen is absorbed at ambient temperature and pressure. The exothermy of the reaction is usually moderate (less than or equal to 35 KJ/mol H2). The hydrogen is subsequently desorbed at ambient temperature and pressure during use. The energy input required to use the hydrogen is reasonable.

Conversely, with light hydrides, the absorption of hydrogen by the light metal hydride requires a higher temperature (approximately 300° C. for MgH2). This reaction is highly exothermic (75 KJ/mol H2). The energy input required to initiate the hydrogen absorption reaction is therefore moderate. On the other hand, the absorption reaction stops spontaneously if the heat generated is not evacuated. Furthermore, during use, the desorption of the hydrogen requires a significant heat input, the reaction being endothermic.

The use of hydrides, in particular light hydrides, therefore requires very precise thermal management, both during absorption and during desorption of the hydrogen.

Furthermore, regardless of the type of hydride used, the absorption/desorption reactions generate an inflation/deflation of the hydride, i.e. a volumetric expansion/contraction of the hydride during the charging/discharging of the hydrogen.

The variation in volume and the thermal variations have to be taken into account when producing the tank and filling the tank with metal hydride, because the mechanical stresses applied to the walls of the tank may cause said tank to crack or even to rupture.

Finally, it has been noted that, on completion of a significant number of cycles, which is nonetheless consistent with normal use, the compacted metal hydride medium “decrepitates”, i.e. crumbles and tends to return to a powdery state.

The present invention is intended to provide a device and a tank for storing hydrogen in a safe solid form (i.e. without risk of rupture under the mechanical stresses resulting from variations in volume during absorption/desorption), that is easy to manufacture, providing rapid hydrogen absorption kinetics.

Document U.S. Pat. No. 6,969,545 describes a tank for storing hydrogen in solid (hydride) form. This tank comprises a single large volume of hydride, with a single inlet and a single outlet, said single large volume being surrounded by a layer of expanded natural graphite (ENG), which is itself in contact with the rigid (non-deformable) wall of the tank. This layer enables heat transfer and may be compressed during hydrogen absorption.

However, the large volume of hydride means that the hydrogen absorption/desorption time is too long for this tank to be usable.

Document FR2939784 also provides a hydrogen storage tank that minimizes variations in volume. It proposes a hydrogen storage tank using a light metal hydride, in particular magnesium hydride, mixed and compacted with a thermally conductive matrix (chosen from the group including ENG, metal felts, non-oxide ceramics and copper foams coated with non-oxide ceramics) and combined with a reversible absorption-heat storage system.

The compacted material may comprise 80% to 99% by weight of magnesium hydride and 20% to 1% by weight of ENG.

The tank comprises at least one tubular container delimited by a thermally conductive wall, immersed in a phase-change material.

Each tubular container contains a plurality of vertically stacked solid pellets formed of a mixture of compacted material comprising metal hydride and particles forming a thermally conductive matrix made of ENG. Each pellet is provided with a central hole intended to receive a porous tube in fluidic communication with the hydrogen inlet and outlet. Metal plates are arranged between each pellet.

The pellets are in a heat-transfer relationship with external phase-change material via the wall of each container, which is made of stainless steel. To manage the expansion issues, this document proposes providing mechanical means for holding the pellets in contact with the wall.

This device is complex, costly and difficult to implement on account of the presence of the phase-change material.

Furthermore, this device may be hazardous because, on account of the use of vertically stacked pellets, hydride powder falls to the bottom of the tank during decrepitation of the pellets and can trigger an explosion under certain operating conditions.

The invention is therefore intended to obviate this risk resulting from the natural and inevitable decrepitation of the metal hydride compact in pellet form.

The invention therefore relates to a solution for storing hydrogen in the form of low-pressure metal hydrides enabling the design and production of hydrogen tanks that are compact, modular, safe (i.e. with no risk of the wall rupturing under the mechanical stresses and no risk of explosion) and that provide enhanced energy efficiency (i.e. having a higher charging speed).

For this purpose, the invention proposes a specific arrangement, notably of metal hydride and ENG, that enables all of these problems to be overcome, specifically limiting the mechanical stresses against the wall of the tank during the hydrogen charging/discharging cycles, limiting the risk of explosion related to the decrepitation, while accelerating the charging speed and charging capacity as a result of improved heat exchange.

The invention relates more specifically to a pellet for storing hydrogen in solid form intended to be incorporated into a hydrogen storage tank, the pellet comprising a peripheral ring of a given external diameter made of expanded natural graphite (ENG) of a given height, surrounding a wafer of a metal hydride in the form of compacted powder.

Thus, the invention proposes not mixing the metal hydride and the ENG, but surrounding the compacted metal hydride pellet with a ring made of ENG, preferably having a sheet structure, and separating these two elements using plates of thermally conductive material.

According to specific embodiments:

the peripheral ENG ring may be formed by an axial stack of annular ENG sheets having a height which is less than the height of the peripheral ring; and/or

the annular ENG sheets may have a height of the order of tenths of a millimeter, preferably between 1 and 5 tenths of a millimeter.

The invention also relates to a tank for storing hydrogen in solid form comprising:

a hollow cylindrical container extending along a longitudinal axis, closed at a first end, open at a second end, delimited by a thermally conductive outer radial wall, and comprising an alternating stack of rigid disks made of a thermally conductive material of a given diameter and pellets mentioned above, each pellet being interposed between two rigid disks, each rigid disk being pierced by a hole and each metal hydride wafer being pierced by a hole facing the hole in the disks to form an axial passage, and

a removable cover for reversibly sealing the second end of the hollow cylindrical container, the cover comprising a hydrogen inlet/outlet orifice.

According to specific embodiments:

the tank may further comprise a passive hydrogen diffusion tube extending axially along the hollow cylindrical container, through the holes in the rigid disks and the hydride wafers of the pellets, and in sealed fluidic communication with the orifice in the removable reversibly-sealing cover;

the passive hydrogen diffusion tube may be made of a material porous to hydrogen;

the hydrogen inlet/outlet orifice may be in fluidic connection with a closing/opening valve;

the hollow cylindrical container may comprise, between a last rigid disk of the stack and the removable reversibly-sealing cover, a free axial expansion space for the stack of pellets; and/or

the tank may be shaped to be used in an elongate position in which the longitudinal axis of the container is horizontal in relation to gravity, the tank further comprising a compression spring between the last rigid disk of the stack and the removable reversibly-sealing cover.

Other features of the invention are set out in the detailed description given below with reference to the attached figures, which are provided as examples and show respectively:

FIG. 1, a schematic perspective view of a stack of hydrogen storage pellets according to the invention between which are intercalated aluminum disks;

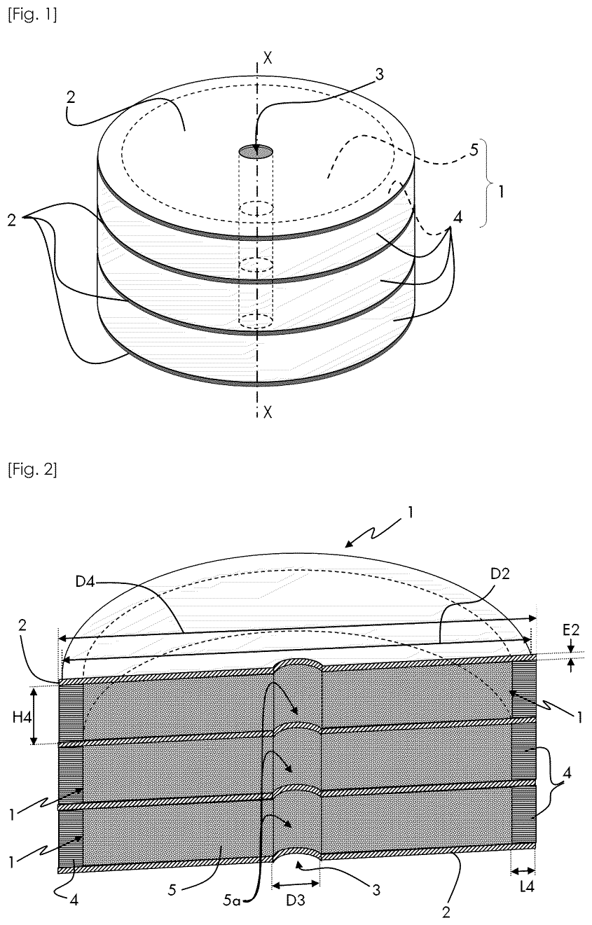

FIG. 2, a schematic cross-sectional view of the stack in FIG. 1;

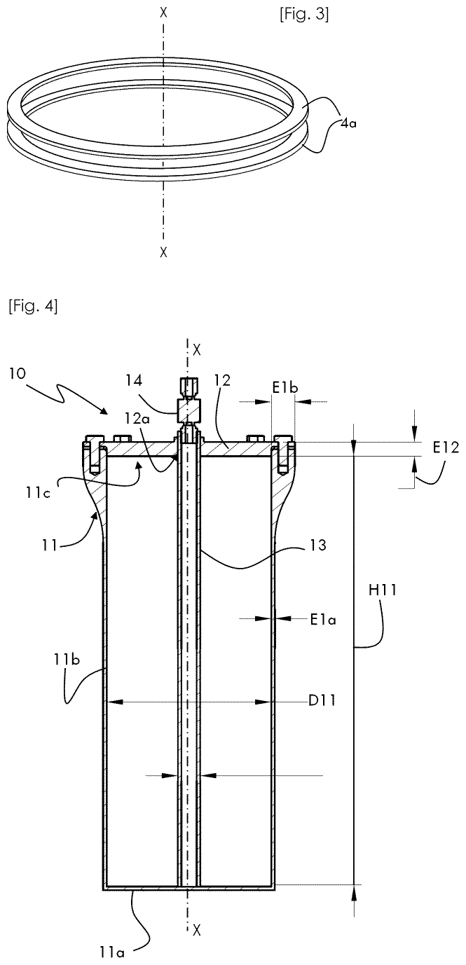

FIG. 3, a schematic perspective view of two ENG sheets of a stack of sheets forming a peripheral ENG ring according to the invention;

FIG. 4, a schematic cross-sectional view of a tank according to the invention;

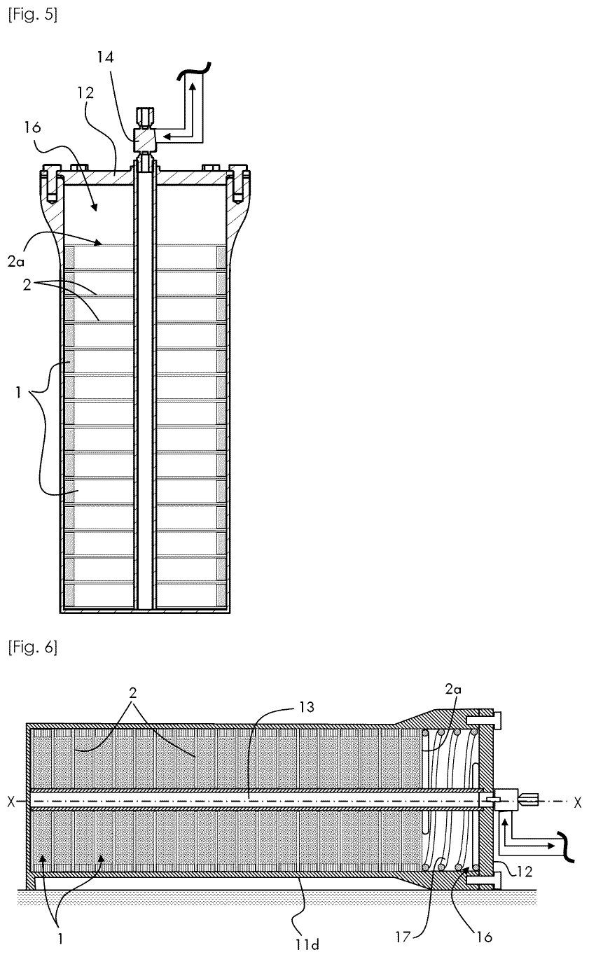

FIG. 5, a schematic cross-sectional view of the tank in FIG. 4 comprising a plurality of pellets according to the invention; and

FIG. 6, a schematic cross-sectional view of a tank according to the invention used in the elongate position.

FIGS. 1 and 2 illustrate a pellet 1 for storing hydrogen in solid form according to the invention. It is intended to be incorporated into a hydrogen storage tank (see FIGS. 5 and 6).

The pellet 1 comprises a peripheral ring 4 of a given external diameter D4 made of expanded natural graphite (ENG) of a given height H4, surrounding a wafer of a metal hydride 5 in the form of compacted powder, also of height H4. The compacted powder is a powder that has been subjected to a uniaxial force of several metric tons, binding the powder and providing a solid, i.e. self-supporting, wafer of metal hydride 5.

The diameter D4 is equal to the internal diameter of the tank in which the pellet 1 is intended to be incorporated to ensure close contact between the ENG ring and the wall of the tank.

FIG. 3 shows a particularly advantageous embodiment, in which the peripheral ENG ring 4 is formed by axially (along the axis X-X in use) superposing a plurality of annular ENG sheets 4a (this figure shows only two sheets). These sheets 4a are of height H4a, which is less than the height H4 of the peripheral ring 4. Preferably, the annular ENG sheets have a height of the order of tenths of a millimeter, preferably between 1 and 5 tenths of a millimeter.

This superposed sheet structure provides surprising efficiency both in terms of absorption of radial stresses, heat transfers, offsetting axial stresses, and stability over time.

Preferably, the metal hydride 5 in the form of a compacted powder is a hydride of the AB2 family of metal hydrides which has a gravimetric storage capacity of up to 1.8 wt. % (kg_H2/kg metal hydride) for moderate operating conditions (moderate pressure, i.e. less than 100 bar, and temperature less than 100° C., preferably ambient temperature).

Advantageously, a metal hydride which functions particularly well with the structure of a pellet according to the invention is the metal hydride marketed under the name Hydralloy C5, which is an alloy based on Ti/Zr/Mn/V/Fe. The powder is initially in the form of particles smaller than 600 μm. After compaction, the apparent density (mass of the powder/apparent volume of the powder) of the metal hydride is 2.93 g/cm³. Its absolute density is 6.41 g/cm³.

This arrangement of the pellet according to the invention ensures that the volume compression/decompression cycles caused by the charging/discharging of hydrogen are particularly well absorbed laterally by the ENG ring, while maintaining the heat transfers, and the charging/discharging speed is much faster than known systems with no peripheral ENG ring.

According to the invention, the pellets 1 are stacked alternately with rigid disks 2 made of thermally conductive material.

In other words, the disks 2 are spaced apart from each other by the peripheral ring 4 of expanded natural graphite (ENG) and the metal hydride wafer 5 against which the disks rest freely, i.e. without being fastened thereto.

The peripheral ENG ring 4 acts as a spacer forming a space between the disks 2 for receiving the metal hydride wafer 5.

Each disk 2 has a diameter D2 that is slightly smaller than the internal diameter of the tank in which it is intended to be stacked to enable the disks 2 to expand during heat transfers and to bring them into contact with the wall 11b of the tank without applying stresses thereto.

Each disk 2 is pierced by at least one hole 3 (in this case a single central hole 3).

The metal hydride wafer 5 also comprises a hole 5a arranged ring-like with respect to the holes 3, so as to leave a free passage through the stack. This free passage allows the hydrogen to circulate to and from the metal hydride 5 of the pellets 1 and to be evacuated via the holes 3 and 5a. As specified below, a tube permeable to hydrogen is advantageously inserted through the holes 3, 5a to convey the hydrogen into the circuit of the tank and of the hydrogen storage system. This tube also makes it possible to filter the hydrogen, i.e. to prevent any metal hydride particle from the wafers 5 from polluting the hydrogen leaving the tank. Finally, this tube also has a mechanical guiding role during the production of the stack in the tank and makes it possible to perfectly center the pellets 1 and the rigid disks 2.

FIG. 2 shows a dimensional embodiment given solely by way of non-limiting example. The proportions are not respected in the figure, which is given merely by way of example.

In this figure, the disks 2 are made of aluminum and have a diameter D2 of 111.8 mm and a thickness E2 of 1 mm. The hole 3 has a diameter D3 of 10.2 mm.

The peripheral ENG ring 4 has a height H4 of 15 mm and a width L4 of 5.6 mm.

More generally, the peripheral ENG ring 4 has a height H4 equal to 5% to 15% of the radius (D4/2).

Advantageously, the ratio of width LA of the peripheral ENG ring to the diameter D2 of the disks is between 3 and 8.

The material of the disks 2 is chosen to optimize the heat transfers and allow the evacuation of the heat in contact with the wall of the tank and the metal hydride wafers 5. It is also chosen to have the lowest possible density. It may, for example, be chosen from stainless steel or copper, but it is advantageously made of aluminum, which optimizes the heat conduction/density ratio. For example, the aluminum disks have a thickness E2 of approximately 1 mm.

FIGS. 4 and 5 illustrate a tank 10 for storing hydrogen in solid form according to the invention, used vertically. It is shaped to incorporate a plurality of pellets 1 according to the invention.

The tank 10 comprises a hollow cylindrical container 11, extending along a longitudinal axis X-X, closed at a first end 11a and delimited by a thermally conductive outer radial wall 11b. The container 11 has a second open end 11c to enable access to the inside of said container.

The tank 10 also comprises a removable cover 12 for reversibly sealing the second end 11c of the hollow cylindrical container 11 to enable access to the inside of the container and to arrange the pellets therein, and for sealing the container for use in hydrogen storage/withdrawal. The cover 12 also comprises a hydrogen inlet/outlet orifice 12a in fluidic connection with a closing/opening valve 14.

The wall 11b of the container in contact with the storage pellets 1 is as thin as possible to optimize the evacuation of heat. Of course, this wall must make it possible to withstand without deformation the operating pressure of the hydrogen and the mechanical compression from the pellets 1. With the pellets according to the invention, the mechanical compression from the pellets 1 is very limited since it is absorbed by the peripheral ENG ring. At the second end 11c, the wall 11b is advantageously thicker to enable fastening of the cover 12.

Preferably, the tank 10 also comprises a passive hydrogen diffusion tube 13 extending axially along the hollow cylindrical container, through the holes 3 in the disks 2 and the holes 5a in the pellets. The tube 13 is also in sealed fluidic connection with the orifice 12a of the removable reversibly-sealing cover.

The tube 13 also facilitates the insertion of the pellets 1 and the disks 2 into the container 11 by centering the assembly and thus ensuring the optimum positioning thereof, in particular with regard to the contact between the peripheral ENG ring 4, the disks 2 and the wall 11b of the container 11. The tube 13 also enables filtering of any residual metal hydride powder during desorption.

The passive hydrogen diffusion tube 13 is a tube made of a material porous to hydrogen so as to enable the absorption/desorption of hydrogen in and out of the metal hydride 5.

The passive hydrogen diffusion tube 13 extends axially (parallel to the longitudinal axis X-X) throughout the container and is connected to a closing/opening valve 14 outside the tank 10 to prevent/authorize the circulation of hydrogen out of or to the tank 10. Advantageously, the valve 14 can be controlled manually and/or automatically by a central unit of the storage system (not shown).

Preferably, the hollow cylindrical container 11 comprises, between a last disk 2a of the stack and the removable sealing cover 12, an axial expansion space 16 for the stack of pellets.

In use (see FIG. 4), the ENG ring 4 of the pellets 1 is arranged between the wall 11b of the tank 10 and the compacted metal hydride 5. In this way, the ENG ring 4 reduces the mechanical stresses exerted on the wall 11b of the tank by absorbing this stress, and improves the thermal conductivity in order to evacuate the heat.

The disks 2 not only enable thermal conduction toward the walls of the tank, but also, on account of the weight thereof, radially guide part of the stresses resulting from expansion of the metal hydride 5 toward the ENG ring 4 during the volume compression/decompression cycles caused by the charging/discharging of the hydrogen, the peripheral ENG ring thus absorbing a large part of the increase in volume of the metal hydride 5 without transmitting the stress to the wall of the tank.

The remainder of the increase in volume of the hydride wafer results in a slight increase in the height of said wafer. In parallel, during absorption of the radial stress, the ENG ring 4 is compressed against the wall and the height H4 thereof also increases, as does the height of the hydride wafer. All of this is enabled because the rigid disks 2 are not rigidly connected to the ENG ring 4 or to the metal hydride wafer 5.

The assembly of pellets 1, disks 2 and expansion space 16 enables the stack to “breathe”, which generates very little radial stress against the tank, and no axial mechanical compression, since the space 16 enables the pellets to expand axially. The latter only results in an increase in hydrogen pressure, which is compatible with the operating pressure, and which the tank can easily withstand with no mechanical risk.

Surprisingly, this lateral guidance of the mechanical stress by the rigid plates 2 toward the ENG ring 4 is also accompanied by a very substantial improvement in the absorption/desorption time of the hydrogen compared to a pellet not provided with a peripheral ENG ring.

This time saving is particularly enhanced with a ENG ring formed by axially superposed sheets 4a, as illustrated in FIG. 3. This superposing of sheets provides anisotropic thermal conductivity properties. Conductivity is significantly greater in the direction perpendicular to the axis X-X.

With a tank dimensioned according to the example below, it is thus possible to store 150 g of gaseous hydrogen in less than 10 minutes.

In a dimensional embodiment provided exclusively by way of non-limiting example, the wall 11a is made of aluminum alloy and has, in the part thereof intended to be in contact with the pellets 1, a thickness E1a of approximately 5 mm, and in the part thereof for fastening the cover 12, a thickness E1b of approximately 20 mm. The cover 12, also made of aluminum alloy, has a thickness E12 of approximately 12 mm.

The container 11 has an internal diameter D11 that is substantially equal to the diameter D4 of the ENG rings 4 of the pellets 1.

“Substantially equal” means a diameter equal to D4 to within manufacturing clearances, which are required to insert the pellets into the tank.

The disks 2 have a diameter D2 that is slightly smaller than the diameter D4 of the ENG rings 4 to enable the expansion thereof during heat transfers and to come into contact with the wall 11b of the tank without applying significant stress thereto.

For example, the internal diameter D11 is 112.1 mm, while the diameter D4 of the ENG rings is 112 mm, and the diameter D2 of the disks is 111.8 mm.

The container 11 has a height H11 that is greater than the height of the stack of pellets 1 to leave a free axial expansion space 16 between the last pellet la of the stack of pellets and the removable reversibly-sealing cover 12. For example, the height H11 is approximately 320 mm, making it possible to store 17 pellets 1 having a total height of 17 mm, and leaving an expansion space 16 of 31 mm in height.

The tank according to the invention can easily be lengthened or shortened depending on the chosen storage capacity, and therefore the number (and the height at equal diameter) of pellets to be installed.

The structure of the stack according to the invention of pellets 1 and of disks 2 also makes the tank particularly safe.

Indeed, as the tank and the pellets age, after many hydrogen charging/discharging cycles, the metal hydride wafers 5 decrepitate, i.e. they tend to become powdery again.

The peripheral ENG rings keep this metal hydride powder between the disks. This peripheral ENG ring 4 ensures that very little powder can fall by gravity against the wall 11a of the first end of the tank. Conversely, in known tanks, which do not have the peripheral ENG rings, lots of powder falls by gravity to the bottom of the tank, posing an explosion risk.

FIG. 6 illustrates an even safer embodiment that is enabled by the structure of the pellets according to the invention. In this embodiment, the tank is used in the horizontal position, i.e. the longitudinal axis X-X thereof is substantially horizontal.

As in the preceding embodiment, the pellets 1 are alternated with the disks 2 about the tube 13. In this embodiment, the tank further comprises, in the expansion space 16, a compression spring 17 between the last rigid disk 2a of the stack and the removable reversibly-sealing cover 12.

This spring 17 keeps the alternating stack of pellets 1 and disks 2 against the wall of the first end 11a of the tank, while enabling the axial expansion during hydrogen charging/discharging cycles.

This embodiment is particularly safe. Indeed, the peripheral ENG rings keep this metal hydride powder between the disks. If, despite everything, powder passes between the ENG ring and the disks, said powder falls by gravity against the wall 11d at the bottom of the tank, in the usage position.

Since this wall 11d is much larger than the wall 11a, the powder cannot accumulate and poses even less explosion risk than in the vertical position.

This device according to the invention is simple while being able to absorb the mechanical stresses resulting from expansion of the metal hydride during hydrogen charging, and is particularly efficient in terms of hydrogen charging times and safety. This efficient charging time is related, surprisingly, to the specific design of the pellets according to the invention, enabling differentiated absorption of the mechanical stress inside the pellets 1 that limits the axial expansion due to the rigid plates 2 and encourages lateral (or radial) expansion, which is absorbed by the peripheral ENG ring 4.

The invention therefore enables the design and production of hydrogen tanks that are compact, lightweight (since a large part of the wall thereof is thin), modular, safe (i.e. with no risk of the wall rupturing under the mechanical stresses and no risk of explosion) and that provide enhanced energy efficiency (i.e. having a higher charging speed).

1. A pellet (1) for storing hydrogen in solid form intended to be incorporated into a hydrogen storage tank (10), the pellet (1) being characterized in that it comprises a peripheral ring (4) of a given external diameter (D4) made of expanded natural graphite (ENG) of a given height (H4), surrounding a wafer of a metal hydride (5) in the form of compacted powder.

2. The pellet as claimed in claim 1, wherein the peripheral ENG ring is formed by an axial stack of annular ENG sheets having a height (H4a) which is less than the height (H4) of the peripheral ring.

3. The pellet as claimed in claim 2, wherein the annular ENG sheets have a height of the order of tenths of a millimeter, preferably between 1 and 5 tenths of a millimeter.

4. A tank (10) for storing hydrogen in solid form, comprising:
a hollow cylindrical container (11) extending along a longitudinal axis (X-X), closed at a first end (11a), open at a second end (11c), delimited by a thermally conductive outer radial wall (11b), and comprising an alternating stack (1a) of rigid disks (2, 2a) made of a thermally conductive material of a given diameter (D2) and pellets (1) as claimed in claim 1, each pellet being interposed between two rigid disks (2, 2a), each rigid disk (2, 2a) being pierced by a hole (3) and each metal hydride wafer (5) being pierced by a hole (5a) facing the hole (3) in the disks to form an axial passage;
a removable cover (12) for reversibly sealing the second end (11c) of the hollow cylindrical container (11), the cover comprising a hydrogen inlet/outlet orifice.

5. The tank (10) as claimed in claim 4, further comprising a passive hydrogen diffusion tube (13) extending axially along the hollow cylindrical container, through the holes (3, 5a) in the rigid disks (2) and the hydride wafers (5) of the pellets (1), and in sealed fluidic communication with the orifice in the removable reversibly-sealing cover.

6. The tank (10) as claimed in claim 5, wherein the passive hydrogen diffusion tube (13) is made of a material porous to hydrogen.

7. The tank (10) as claimed in claim 4, wherein the hydrogen inlet/outlet orifice is in fluidic connection with a closing/opening valve (14).

8. The tank (10) as claimed in claim 4, wherein the hollow cylindrical container (11) comprises, between a last rigid disk (2a) of the stack and the removable reversibly-sealing cover (12), a free axial expansion space (16) for the stack of pellets (1, 1a).

9. The tank (10) as claimed in claim 8, shaped to be used in an elongate position in which the longitudinal axis (X-X) of the container is horizontal in relation to gravity, the tank (10) further comprising a compression spring between the last rigid disk (2a) of the stack and the removable reversibly-sealing cover (12).
